(19) United States
(12) Patent Application Publication
(10) Pub. No.: US 2019/0001869 A1
(43) Pub. Date: Jan. 3, 2019

(54) ILLUMINATED TRIM

(71) Applicant: Dura Automotive Holdings U.K., Ltd, Birmingham (GB)

(72) Inventors: Torsten Hundt, Neuenrade (DE); Martin Schulte, Balve (DE); Stephan Rohner, Dortmund (DE)

(21) Appl. No.: 16/021,837

(22) Filed: Jun. 28, 2018

(30) Foreign Application Priority Data
Jun. 29, 2017 (EP) 17178782.3

(51) Int. Cl. B60Q 1/26; B60Q 1/00; B60Q 1/32; B60R 13/04; B60J 10/265; B60J 10/75; F21S 45/50

(52) U.S. Cl. CPC B60Q 1/268; B60Q 1/0017; B60Q 1/323; F21S 45/50; B60J 10/265; B60J 10/75; B60R 13/04

(57) ABSTRACT

The invention relates to an illuminated trim for a motor vehicle with a lighting unit, especially a trim as the cover strip of a sealing strip for a window shaft of a vehicle door, which is designed such that, when assembled as intended on the vehicle a light gap is formed between the trim and the adjoining outer surface of the vehicle or in the trim, as well as the method for making such a trim. In order to achieve a uniform ambient lighting with high functional reliability, low manufacturing expense, and the lowest possible costs, it is provided that the lighting unit comprises a carrier layer and an at least partly translucent functional layer, wherein the light source is arranged on the carrier layer and the light source is covered by the functional layer applied to the carrier layer.

### FIELD

The invention relates to a trim for a motor vehicle, to a method for manufacturing such a trim and to a vehicle comprising the trim.

The trim according to the invention comprises at least one lighting unit with at least one light source, wherein the trim when assembled as intended on the vehicle defines a decorative side directed away from the vehicle and an inner side directed toward the vehicle, as well as a cavity on the side of the trim facing away from the decorative side, and it is designed and intended to be mounted on a motor vehicle or a component arranged on the motor vehicle, especially on a sealing profile, and to be carried by the latter, wherein the cavity is designed such that light may escape through a light gap from the cavity and the lighting unit is arranged in the cavity.

The emitted light may be reflected in particular at the inner side of the trim, at the vehicle body, or at parts of the sealing profile.

### BACKGROUND

EP 3 100 910 A1 discloses an illuminated trim for vehicles. The trims are used for the optical effects or also for safety purposes due to the illumination of the outer body of a vehicle.

A covering device is known from DE 20 2014 002 763 U1 which serves for at least partial covering of a depression in a flat section, a curved section, and/or a stepped section of at least one vehicle body component and/or a vehicle element of a vehicle. This covering device has a lighting device and is designed such that the lighting device can shine through at least one section of the covering device.

DE 10 2014 015 186 A1 discloses a mounted part for arrangement on a vehicle component with a carrier arrangement, at least one light source arranged on the carrier arrangement, and a cover element, which covers at least partly the carrier arrangement and the light source. The carrier arrangement, the light source, and the cover element are designed and arranged relative to each other such that, in the state mounted on the vehicle component, a gap is formed between the cover element and the vehicle component, wherein the gap is oriented such that a light distribution can be generated on the vehicle component and/or in its surroundings by means of light coupled out from the light source.

Furthermore, DE 10 2015 100 327 A1 describes an illuminated trim for a motor vehicle, which is supposed to achieve an elegant lighting effect and moreover differs externally as little as possible from non-illuminated trims by forming a light gap between a profile strip of the trim and the adjacent outer skin of the vehicle, through which light emitted by an optical fibre provided on the back side of the trim can emerge to the outside. A similar trim is also known from DE 10 2015 015 748 A1.

In the above-described illuminated trims, the lighting unit consists of the at least one light source and optical fibres. The optical fibres used, on account of limiting minimum bending radii, may result in an inhomogeneous and thus visually unappealing ambient illumination of the trims. Furthermore, in other variants there is sometimes an inadequate protection of the electronics (light source, electrical components/switching elements, conductor tracks) against moisture and grime in the exterior region of the vehicle. Moreover, no individual light control is possible along the length, such as is used in the rear direction indicators of more modern vehicles.

It is one object of the invention to provide an alternative to the known illuminated trims in which a uniform ambient illumination is achieved with high functional reliability and low manufacturing expense. Furthermore, the external appearance of the trim should not differ significantly from that of non-illuminated trims.

### SUMMARY

According to one aspect of the invention, this problem is solved by an illuminated trim of the kind mentioned above, in which the light source of the lighting unit is arranged on a carrier layer and is at least partly covered by a translucent functional layer applied to the carrier layer. The cavity in which the at least one lighting unit is arranged may be bounded by the trim and the outside of the vehicle body or the sealing profile. Alternatively, the cavity may also be arranged inside a margin of the trim, especially a bottom margin, or even in the sealing profile. The trim can be mounted on a motor vehicle by placing it on a sealing profile located there or alternatively it can be designed as a separate structural unit carrying the sealing profile and be placed along with the sealing profile on the vehicle.

The functional layer, besides protecting the electronic components, also brings about in particular a specific distribution or a homogenization in the region of the light source of the light emitted from the at least one light source. Preferably, several light sources are arranged on the carrier layer, whose spacing and beam angles are organized such that a homogeneous lighting is achieved over the length of the trim. Furthermore, an individual light control over the length may also be provided, in order to be able to realize indication/warning functions and/or a visually appealing effect of the vehicle.

The light sources used according to one aspect of the invention comprising LEDs as lightning means, which are applied as surface-mounted components (SMD=surface mounted device) to the carrier layer. The LEDs may be designed with and/or without a housing wherein the housing is part of the LEDs and does according the one aspect of the invention does not does not perform the function of the function layer. Other light sources such as OLEDs, OLETs, electroluminescent films or lighting means which may become available in future may also be used as the light source.

In one preferred embodiment, the lighting unit comprises electronic components, especially control electronics, and conductor tracks, which are printed on the carrier layer. Alternatively, however, other manufacturing techniques can be used for applying the electronic components and conductor tracks to the carrier layer.

The applying of the functional layer is done preferably by overmoulding using an injection moulding process. The functional layer is preferably formed of plastics, such as PMMA or PC. Due to the covering of the light sources and electronic components, a protection against harmful environmental factors is achieved, which promotes the age resistance and the functional reliability. Furthermore, the ends of the lighting unit can also be made translucent or transparent. Due to the eliminating of shadows at the ends of the structural parts, the illumination of the trim according to the invention can be improved. In particular, a homogeneous ambient lighting becomes possible. Furthermore, this also allows the elimination of end caps, which are necessary by design in conventional lighting means, resulting in a smaller space requirement.

According to one aspect of the invention the lighting means are printed directly on the carrier layer. For example, a vapour deposition of one or more light sources on the carrier layer is also possible.

The printing of the light sources and/or the electronic components including the conductor tracks on the carrier layer and its subsequent overmoulding enables a design of the lighting unit with low structural height, which is aesthetically pleasing.

The use of modern, printed electronic components makes it possible to replace conventional lighting methods. The mounting of the structural part is appreciably simplified by the integration of the lighting means in the trim. In addition, closer tolerances can be achieved. The ends of the light source unit can furthermore be made transparent. The overmoulding of the electronic components achieves a better protection of the components. Furthermore, fewer assembly steps are required for the mounting of the illuminated trim.

In one preferred embodiment, a thinner or thicker film made of plastics forms the carrier layer of the lighting unit. The fastening of the film then occurs on the inner side of the trim and/or on the sealing profile. The thickness of the film can be less than 1 mm, preferably less than 0.5 mm.

In another preferred embodiment, the lighting unit is formed by a laminated film, on which the light sources and/or electronics are printed prior to the lamination, the lighting unit being arranged on the inner side of the trim and being secured, in particular by bonding.

Another preferred embodiment calls for the carrier layer to be formed by at least one portion of the inner side of the trim. Thus, the electronic components and/or the conductor tracks are printed directly on the inner side of the trim. The light sources, i.e., in particular the LEDs, are likewise preferably printed on the inner side of the trim and/or surface mounted, thus being integrally bonded to the conductor tracks and/or electronic components.

In another possible embodiment, at least one portion of the sealing profile on the inner side of the trim forms the carrier layer. The above-described embodiments of surface mounting/printing likewise find application here, according to the invention.

In order to convey an especially aesthetic visual impression, according to the invention light scattering elements are provided in the translucent regions of the functional layer, which reflect and/or diffract at least partly the light emitted by the light source. For example, the light scattering elements may be formed by paint pigments.

A homogeneous and visually appealing illumination may also be achieved advantageously by the functional layer being multilayered and/or having at least one totally reflective boundary layer. The totally reflective boundary layer preferably extends over the length of the functional layer.

In order to accomplish an attractive light emission behaviour, it is preferably provided that the outside of the functional layer is provided with a structure or a pattern and/or with a contour. For example, an especially uniform or also a selective lighting of the trim can be accomplished in this way. Definite colours and/or contour patterns can also be realized in this way.

Another embodiment of the invention provides that an additional layer is provided between carrier layer and functional layer with different optical properties as compared to the functional layer or a hollow chamber filled with gas or air for the distribution of the light emitted from the at least one light source.

The lighting unit may comprise additional electronic components, especially control electronics/voltage converters, which are preferably arranged in the vehicle interior and/or on the inner side of the trim, connections between the electronic components and the light sources being provided by means of current conductors. The integration in the vehicle interior is advantageous in regard to the available design space and because of the lower requirement for electrical protection. Preferably, the electronic components can be mounted afterwards.

The electrical connection of the electronic components to the conductor tracks is done preferably by current conductors in the form of conductor tracks and/or separate cables.

Another aspect of the invention is to provide a method for manufacturing the illuminated trim as described above. In the method, a covering of at least the light sources arranged on the carrier layer with a translucent material is provided such that the light sources are entirely encapsulated by the carrier layer and the functional layer. The covering is done by using an injection moulding process wherein in the film is inserted into a mould and subsequently covered by injecting a plastic material. Another possibility of this step is to insert the film into an extruder and pull it off through the die together with the extruded functional layer.

Preferably, the method according to the invention comprises the step of printing of the electronic components and/or the conductor tracks on the carrier layer before the applying of the functional layer.

Furthermore, the method preferably provides that the LEDs are surface mounted on the carrier layer before the applying of the functional layer. Alternatively and/or additionally, according to the invention, the LEDs are printed on the carrier layer before the providing of the functional layer.

In one embodiment of the carrier layer as a film, the method according to the invention involves the step of securing the film to the inner side of the trim or the sealing profile. This step is done after the applying of the electronic components and/or conductor tracks and/or the light source, but prior to the applying of the functional layer.

The laminating prior to the applying of the functional layer also constitutes one aspect of the invention.

The aforementioned features and embodiments are intended in particular for the geometrical configurations of a trim and its fastening as set forth in the patent applications DE 10 2015 100 327 A1 and DE 2 930 062 A1, whose combinations likewise form possible embodiments of the invention.

Insofar as the term “approximately” is used in the instant invention, this term specifies a tolerance range, which the person of skill in the art in the instant field considers to be common. In particular, a tolerance range of up to plus or minus 20 percent, preferably of up to plus or minus 10 percent, is to be understood by the term “approximately”.

Further areas of applicability will become apparent from the description provided herein. It should be understood that the description and specific examples are intended for purposes of illustration only and are not intended to limit the scope of the present invention.

### DRAWINGS

The drawings described herein are for illustration purposes only and are not intended to limit the scope of the present disclosure in any way.

FIG. 1 shows one embodiment of an illuminated trim fastened on a sealing profile;

FIG. 2 shows a cut-out feature of the illuminated trim according to a preferred aspect of the invention in connection with a second embodiment;

FIG. 3 shows a cut-out feature of the illuminated trim according to another aspect of the invention;

FIG. 4 shows a cut-out feature of the illuminated trim according to another aspect of the invention in connection with a third embodiment; and

FIG. 5 shows a top view of the lighting unit in connection with a third embodiment further embodiment of the invention.

### DETAILED DESCRIPTION

FIG. 1 shows one possible embodiment of an illuminated trim 2 formed as a cover strip of a sealing profile 6 for the window shaft of a vehicle door. The sealing profile 6 is placed on a body part of a motor vehicle by its U-shaped section, reinforced with an inserted metal bracket, and seals off the door shaft from the window pane. The trim 2 is formed by a profile strip 4 with an arc-shaped main leg and several lateral functional legs 20. The profile strip 4 when mounted as intended defines a decorative side Z directed away from the vehicle and an inner side I directed toward the vehicle. The dash and dot line indicated in the figure illustrates the boundary between the decorative side Z and the inner side I.

The functional legs 20 are arranged on the inner side I of the profile strip 4 and are in engagement with the correspondingly shaped sealing profile 6. The engagement of the profile strip 4 with the sealing profile 6 is such that a cavity 5 is provided between the lower visible edge of the profile strip 4 and the outer surface of the vehicle body 18 when the trim 2 is properly mounted, from which light can shine to the outside across a gap S.

In the lower region of the trim 2, a lighting unit 8 is arranged on the inner side I of the profile strip 4. In the side view shown, one can recognize an electronic component 16 and a functional layer 12 of the lighting unit 8 surrounding the electronic component 16. The light source 10 (not shown) and the electronic component 16 are fastened to the lower functional leg 20 of the trim 2. The functional layer 12 is placed on top of the light source 10 (not shown) and the electronic component (electrical component) 16 in such a way that both the light source 10 and the electronic component 16 are entirely encapsulated on the outside. The functional layer 12 is designed to be at least partly translucent and/or transparent. In this way, the light emitted by the lighting unit 8 can emerge from the light gap S beneath the trim and thus produce an especially appealing visual effect.

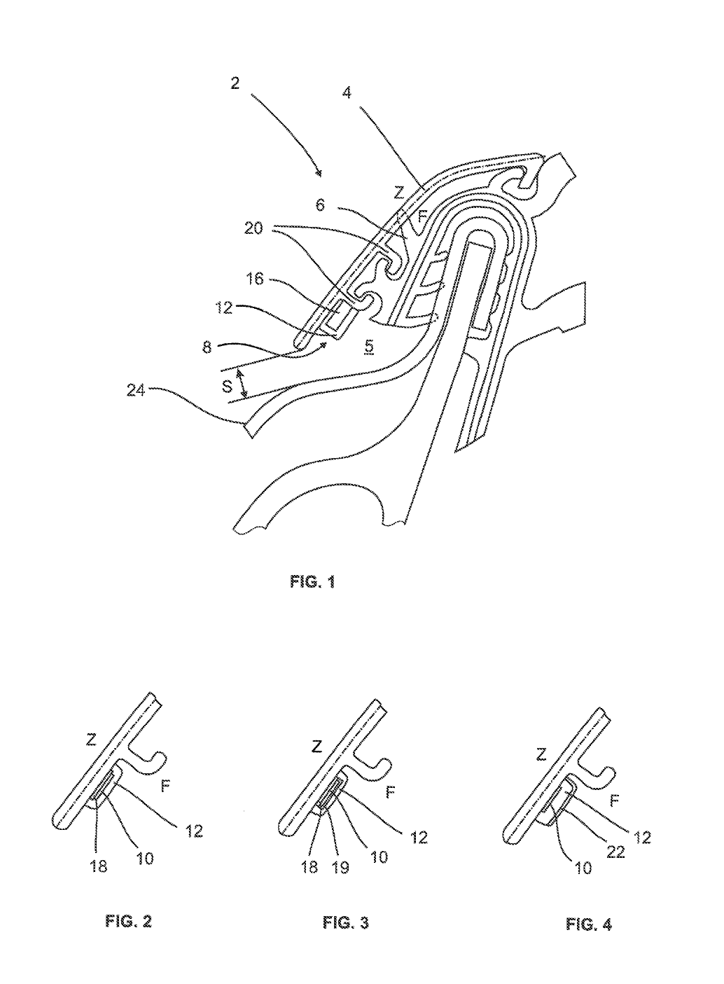

FIGS. 2 to 4 show the section of the profile strip 4 of FIG. 1 with different embodiments of the lighting unit 8 each time. The arrangement of the lighting unit 8 on the profile strip does not change in the depicted figures. It is also provided to arrange the lighting unit 8 for example on the lower functional leg 20 or also on the sealing profile 6.

FIG. 2 shows a lighting unit 8 with a carrier layer formed as a film 18, on which the light sources 10 are arranged. The film 18 is fastened on the inner side I of the profile strip 4 and overmoulded with a light-transmitting material. The embodiment of the lighting unit 8 shown in FIG. 3 has another laminated layer 19 as compared to the embodiment in FIG. 2. The laminated layer 19 is located above the light sources 10 and portions of the electronics (not shown). The functional layer 12 in turn covers the structure and prevents dirt and moisture from getting in.

FIG. 4 shows another embodiment of the lighting unit 8, in which the carrier layer is formed by a portion of the profile strip 4. The light sources 10 and the electronics are applied directly on the profile strip 4, for example by printing and/or surface mounting, and overmoulded with a translucent or light-transmitting material forming a functional layer 12. The functional layer 12 has a multilayered structure for a portion, whose top layer is formed by a totally reflective layer 22. No reflective layer 22 is provided on the side of the functional layer 12 facing the light gap S. In this way, an orienting of the light emitted by the light sources 10 in the direction of the light gap S is accomplished.

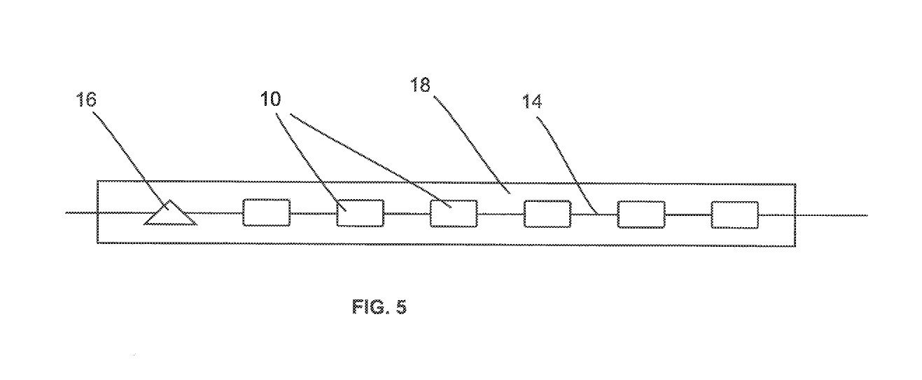

FIG. 5 shows the top view of a lighting unit 8 for an illuminated trim 2 in one possible embodiment. It presents several light sources 10 arranged alongside each other, and an electronic component 16, being connected to each other by conductor tracks 14. A striplike film 18 forms the carrier layer for the light sources 10, the conductor tracks 14 and the electronic component 16. The light sources 10 are surface mounted here, but may also be printed directly on the film 18. The spacing of the light sources 10 and their beam angles are designed such that a homogeneous lighting is produced along the length of the film 18.

The light sources 10 used are preferably LEDs or OLEDs. But the direct use of electroluminescent films also constitutes one application possibility. The film 18 is secured to the inner side I of the trim 2. This is preferably done by bonding on the profile strip 4 or the sealing profile 6. After this, the structure is overmoulded with a light-transmitting and/or transparent material in one or more layers. The resulting functional layer 12 forms an encapsulation and protects the light sources 10 and the electronics against harmful influences in the vehicle outside region, especially dirt, moisture, and the oxygen of air. In this way, the colour and age resistance and thus the functional reliability of the lighting unit 8 can be increased. As a further assistance, the surface-mounted or printed film 18 may also be laminated prior to the bonding and overmoulding.

The description of the present invention is merely exemplary in nature and variations that do not depart from the gist of the present disclosure are intended to be within the scope of the present disclosure. Such variations are not to be regarded as a departure from the spirit and scope of the present invention.

### TABLE OF REFERENCE NUMBER

2 Illuminated trim
4 Profile strip
5 Cavity
6 Sealing profile
8 Lighting unit
10 Light source
12 Functional layer
14 Conductor tracks
16 Electronic component
18 Film
19 Laminated layer
20 Profile leg
22 Totally reflective layer
24 Vehicle outer surface
S Light gap width
Z Decorative side
I Inner side

What is claimed is:

1. An illuminated trim for a motor vehicle comprising:
at least one lighting unit with
at least one light source comprising multiple lighting means;
wherein the trim when assembled as intended on the vehicle defines a decorative side directed away from the vehicle and an inner side directed toward the vehicle, as well as a cavity on the side of the trim facing away from the decorative side, and it is designed and intended to be mounted on a motor vehicle or a component arranged on the motor vehicle, and to be carried by the motor vehicle;
wherein the cavity is designed such that light may escape through a light gap from the cavity and the lighting unit is arranged in the cavity; and
wherein light source of the lighting unit is arranged on a film as a carrier layer and is at least partly covered by a translucent functional layer applied to the carrier layer and wherein the lighting means of the light source are arranged on the carrier layer which is applied to the inside of the decorative strip and subsequently overmolded.

2. The illuminated trim of claim 1 wherein the lighting means are light emitting diodes (LEDs).

3. The illuminated trim of claim 1 wherein the trim is intended to be mounted on a sealing profile.

4. The illuminated trim of claim 2, wherein that the at least one light source of the lighting unit is formed by surface-mounted components (SMDs) and/or is printed on the carrier layer.

5. The illuminated trim of claim 1, wherein the lighting unit comprises electronic components and/or conductor tracks, which are printed on the carrier layer.

6. The illuminated trim of claim 1, wherein the carrier layer is formed by a film which is fastened on the inner side of the trim.

7. The illuminated trim of claim 1, wherein the carrier layer is formed by a film which is fastened on the inner side on the sealing profile.

8. The illuminated trim of claim 1, wherein at least one part of the inner side of the trim forms the carrier layer or wherein at least one part of the inner side of the sealing profile forms the carrier layer.

9. The illuminated trim of claim 1, wherein the carrier layer is formed by one part of the inner side of the trim and by one part of the sealing profile.

10. The illuminated trim of claim 1, wherein the functional layer is designed such that it can afford a protection to the electronic components and it can bring about a distribution of the light emitted from the at least one light source, especially for homogenization in the surrounding region of the light source by scattering effects, wherein the distribution is realized by the surface structure of the functional layer and/or by particles within the functional layer.

11. The illuminated trim of claim 1, characterized in that an additional layer is provided between carrier layer and functional layer (12) with different optical properties as compared to the functional layer or a hollow chamber filled with gas or air for the distribution of the light emitted from the at least one light source.

12. The illuminated trim of claim 10 or claim 11, wherein the particles form light scattering elements in the functional layer, which at least partly reflect and/or diffract the light emitted by the light source.

13. The illuminated trim according of claim 2, wherein the functional layer is multilayered and/or has at least one totally reflective boundary layer.

14. The illuminated trim of claim 1, wherein the lighting unit comprises additional electronic components, wherein the electronic components are arranged in the vehicle interior and/or on the inner side of the trim, wherein a connection between the electronic components and at least the light source is provided by means of current conductors.

15. A method for manufacturing an illuminated trim for a motor vehicle comprising:
at least one lighting unit with
at least one light source comprising multiple lighting means;
wherein the trim when assembled as intended on the vehicle defines a decorative side directed away from the vehicle and an inner side directed toward the vehicle, as well as a cavity on the side of the trim facing away from the decorative side, and it is designed and intended to be mounted on a motor vehicle or a component arranged on the motor vehicle, and to be carried by the motor vehicle;
wherein the cavity is designed such that light may escape through a light gap from the cavity and the lighting unit is arranged in the cavity; and
wherein light source of the lighting unit is arranged on a film as a carrier layer and is at least partly covered by a translucent functional layer applied to the carrier layer, comprising the steps of:
positioning the lighting unit with the one light source comprising multiple lighting means on the carrier layer;
covering the carrier layer and light source the functional layer made consisting of translucent material such that the light source is entirely encapsulated by the carrier layer and the functional layer and wherein the encapsulation is carried out by overmolding the lighting means of the light source subsequently to the arrangement of the lighting means on the film-like carrier layer.

16. The method for manufacturing an illuminated trim for a motor vehicle of claim 15, wherein the electronic components and/or the conductor tracks are printed on the carrier layer before the applying of the functional layer.

17. The method for manufacturing an illuminated trim for a motor vehicle of claim 15 wherein the lighting means, designed as diodes, are surface mounted on the carrier layer before the applying of the functional layer.

18. The method according to claim 15, wherein the light source, designed as diodes, is printed on the carrier layer before the providing of the functional layer.

19. The method of claim 15, wherein after printing or surface mounting and before applying of the functional layer the film-like carrier layer is secured to the inner side of the trim or to the sealing profile.

20. A motor vehicle comprising:
an illuminated trim for with a lighting unit, wherein the lighting unit comprises at least one light source with multiple lighting means;
wherein the illuminated trim is being assembled on the outside of a body of the vehicle and defines a decorative side directed away from the vehicle body and an inner side directed toward the vehicle body, as well as a cavity on the side of the trim facing away from the decorative side;
wherein the cavity is designed such that light may escape through a light gap from the cavity and the lighting unit is arranged in the cavity; and
wherein light source of the lighting unit is arranged on a film as a carrier layer and is at least partly covered by a translucent functional layer applied to the carrier layer and wherein the lighting means of the light source are arranged on the carrier layer which is applied to the inside of the decorative strip and subsequently overmolded.
